(19) United States
(12) Patent Application Publication
(10) Pub. No.: US 2009/0135073 A1
(43) Pub. Date: May 28, 2009

(54) ELECTRONIC DEVICE

(75) Inventors: Satoshi YOKOTE, Ome-shi (JP); Fuminori YAMAZAKI, Fussa-shi (JP); Tomomi MURAYAMA, Nishitama-gun (JP); Toshio OE, Ome-shi (JP); Kentaro TOMIOKA, Sayama-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/195,720

(22) Filed: Aug. 21, 2008

(30) Foreign Application Priority Data
Nov. 28, 2007 (JP) 2007-307722

(51) Int. Cl. H01Q 1/24

(52) U.S. Cl. 343/702

(57) ABSTRACT

According to one embodiment, an electronic device includes a housing including a bottom wall and a side wall rising from an circumference of the bottom wall, an antenna formed on inner surface of the housing, and a part contained inside the housing and having a radio wave absorption property. The part having a radio wave absorption property is arranged with a predetermined gap maintained relative to the side wall of the housing, and at least a part of the antenna is formed in tight contact with an inner surface of the side wall of the housing.

### CROSS-REFERENCE TO RELATED APPLICATIONS

This application is based upon and claims the benefit of priority from Japanese Patent Application No. 2007-307722, filed Nov. 28, 2007, the entire contents of which are incorporated herein by reference.

### BACKGROUND

1. Field

One embodiment of the present invention relates to an electronic device including an antenna, which is used in radio communications.

2. Description of the Related Art

For example, a Japanese patent application, namely, Jpn. Pat. Appln. KOKAI Publication No. 2005-167911 discloses a composite antenna including two antennas which can deal with polarized waves different from each other. This composite antenna includes a substrate on which a patch antenna is provided, a cover which covers over the substrate, and an antenna pattern printed on an outer surface of the cover. The cover has such a shape that a square bowl is tuned upside down.

In this composite antenna, the patch antenna is contained in an inner side of the cover. Further, the antenna pattern is formed on the outer surfaces of the upper wall and the side wall of the cover.

However, in the conventional composite antenna described above, the antenna pattern is formed on the upper wall of the cabinet. With this structure, it is necessary to provide a gap of a predetermined length between the antenna pattern and the patch antenna, in order to inhibit the interference of radio wave from occurring them. This requires a tall cover, which results in the increase in size of the composite antenna.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary diagram showing a perspective view of a portable computer which is an example of the electronic device according to the first embodiment;

FIG. 2 is an exemplary diagram showing a perspective view of a display unit of the portable computer shown in FIG. 1, while the mask is removed;

FIG. 3 is an exemplary diagram showing a perspective view of a cover of the display unit shown in FIG. 2;

FIG. 4 is an exemplary diagram showing a perspective view of a cover of a display unit of a portable computer according to the second embodiment;

FIG. 5 is an exemplary diagram showing a perspective view of a portable computer according to the third embodiment;

FIG. 6 is an exemplary diagram showing a perspective view of the portable computer shown in FIG. 5, while a first portion of the housing is removed; and

FIG. 7 is an exemplary diagram showing a perspective view of the portable computer shown in FIG. 6, while a disk device is removed.

### DETAILED DESCRIPTION

Various embodiments according to the invention will be described hereinafter with reference to the accompanying drawings. In general, according to one embodiment of the invention, an electronic device includes a housing including a bottom wall and a side wall rising from an circumference of the bottom wall, an antenna formed on inner surface of the housing, and a part contained inside the housing and having a radio wave absorption property. The part having a radio wave absorption property is arranged with a predetermined gap maintained relative to the side wall of the housing, and at least a part of the antenna is formed in tight contact with an inner surface of the side wall of the housing.

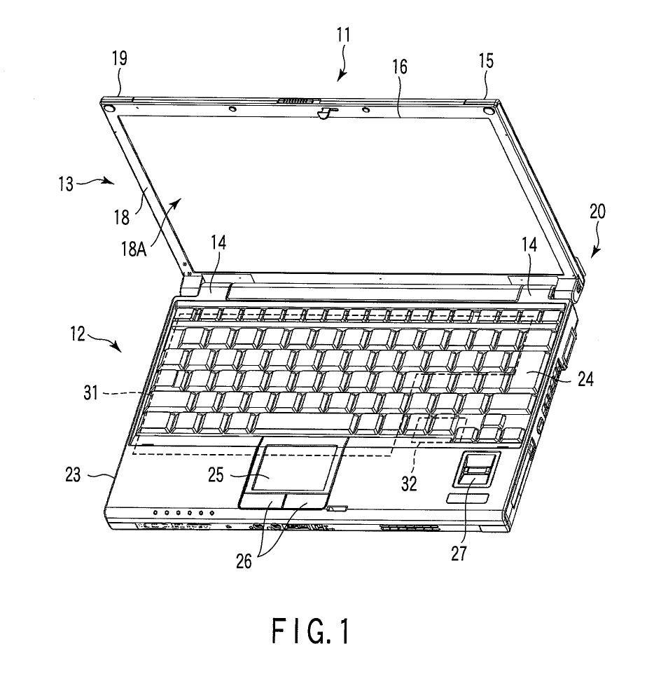

An embodiment of the electronic device will now be described with reference to FIGS. 1 to 3. In this embodiment, a case in which the present invention is applied to a portable computer, which is the so-called notebook personal computer, as an example of the electronic device will be discussed.

As can be seen in FIG. 1, a portable computer 11 includes a main body unit 12, a display unit 13 and a hinge portion 14 provided between the main body unit 12 and the display unit 13. The hinge portion 14 supports the display unit 13 to as to be pivotable.

The display unit 13 can be pivoted by the hinge portion 14 between a close state in which the display unit 13 is closed onto the main body unit 12 and an open state in which it is opened from the main body unit 12.

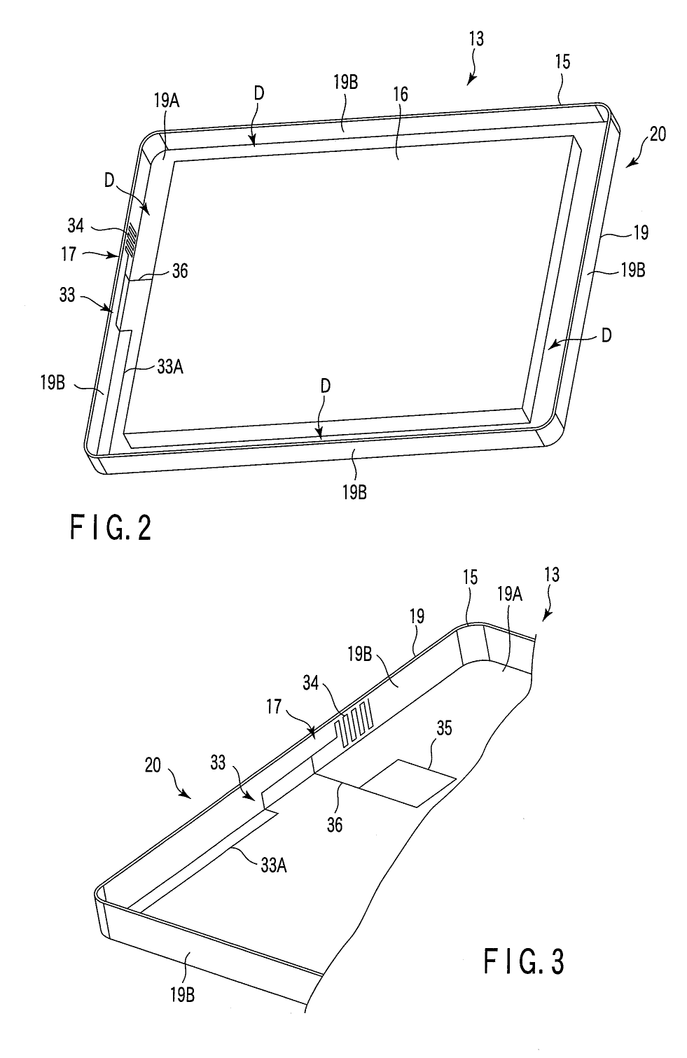

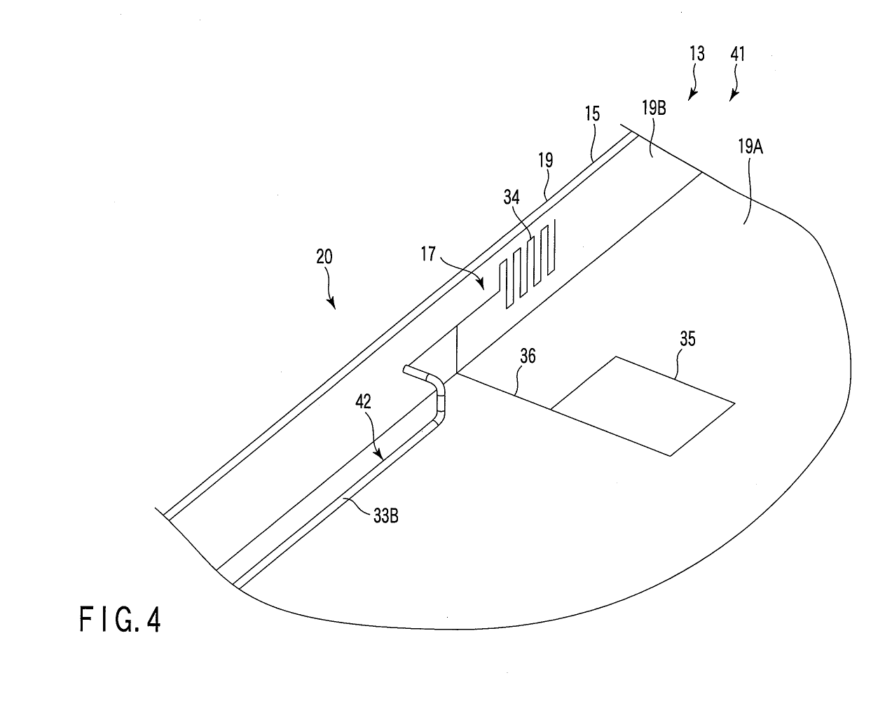

As is illustrated in FIGS. 1 to 3, the display unit 13 includes a display cabinet 15, a liquid crystal display 16, which is an example of the display, contained inside the display cabinet 15, and a plurality of antennas 17 built in an inner surface of the display cabinet 15. The display cabinet 15 is formed of, for example, a synthetic resin. The display cabinet 15 includes a frame-like mask 18 disposed to correspond to a front surface of the liquid crystal display 16, and a cover 19 disposed to correspond to a rear surface of the liquid crystal display 16 and having a bottom wall 19A and a side wall 19B. The mask 18 has an opening portion 18A which expose the front surface of the liquid crystal display 16 to the outside. The side wall 19B of the cover 19 rises from the circumference of the bottom wall 19A in the direction perpendicular to the bottom wall 19A. It should be noted here that there is only one antenna 17 shown in FIGS. 2 and 3 to make the explanation simple.

The main body unit 12 includes a main body cabinet 23 made of a synthetic resin, a keyboard 24, a touch pad 25 and buttons 26, which serve as a pointing device, and a finger print authentication device 27. The main body cabinet 23 includes a conductive ground layer, which is not shown in the figures, on an inner surface thereof. As shown in FIG. 2, the main body unit 12 houses inside itself a print circuit board 31, a plurality of electronic parts mounted on the print circuit board 31 and a wireless module 32. The main body unit 12 includes a wiring portion 33 arranged to be astride the main body unit 12 and the display unit 13. The wiring portion 33 includes a wiring pattern 33A formed by printing on an inner surface of the display cabinet 15 and a coaxial cable which is set to be astride both of the main body unit 12 and the display unit 13 through the inside of the hinge portion 14. The wiring portion 33, by one end portion, is connected to the wireless module 32 via the coaxial cable. Further, the wiring portion 33, by the other end, is connected to the antenna 17 via the wiring pattern 33A. The coaxial cable is connected to the wiring pattern 33A in the vicinity of the hinge portion 14. The diameter of the coaxial cable is, for example, 0.8 mm. The wiring pattern 33A is connected to a conductive portion 36 which connects an antenna element 34 and an antenna ground 35 to each other. It should be noted here that the concept of the housing 20 includes the main body cabinet 23 and the display cabinet 15.

As shown in FIGS. 3 and 4, the antenna 17 is formed of a cover 19 of the display cabinet 15. More specifically, the antenna 17 is formed as a metal coating film tightly attached to the inner surface of the cover 19. The antenna 17 includes the antenna element 34, with which transmission and reception of electromagnetic waves are mainly carried out, and the antenna ground, which is provided mainly to broaden the band of the radio frequencies. The antenna element 34 is formed to have such a pattern that it can be bent at right angles a plurality of times. The antenna element 34 is formed on the inner surface of the side wall 19B of the cover 19 of the display cabinet 15. The antenna ground 35 is formed as a conductive pattern painted in square. The antenna element 35 is formed on the inner surface of the side wall 19A of the cover 19.

The antenna element 34, the antenna ground 35, the conductive portion 36 and the wiring pattern 33A can be formed by performing, for example, printing (screen printing) on the inner surface of the cover 19 of the display cabinet 15. The antenna element 34, the antenna ground 35, the conductive portion 36 and the wiring pattern 33A is formed by stacking thin films of, for example, copper, nickel and gold one on another by screen printing, and the thickness of the stacked multilayer is, for example, 20 μm. The method for forming these films is not limited to the screen printing, but for example, spray painting, vacuum deposition method, sputtering method or plating method can be used solely or in any combination of these.

It should be noted that there are actually a plurality of antennas 17 formed on the cover 19 of the display cabinet 15 although FIG. 3 shows only one of them. These antennas 17 are formed compatible with communication systems such as Bluetooth (registered trademark), wireless LAN, wireless WAN, WiMAX, UWB and GPS, or mobile phone systems such as 3G and 3.5G. Alternatively, it is possible to form an antenna pattern on each of the right and left sides of the side wall 19B as a dipole antenna. It should be noted that the communication systems with which these antennas 17 are compatible are not limited to those mentioned, but also some other systems.

The liquid crystal display 16 of this embodiment contains a plurality of metal wires arranged in lattice, and is an example of the member having a radio wave absorption property. As shown in FIG. 2, the liquid crystal display 16 is located in a central portion of the display cabinet 15. With this arrangement, there is a predetermined gap D created between the liquid crystal display 16 and the side wall 19B of the cover 19. Therefore, an interval of a predetermined distance is secured between the antenna element 34 formed on the inner surface of the side wall 19B of the cover 19 and the liquid crystal display 16. With this interval, it is possible to prevent the radio waves transmitted from and received with the antenna 17 from being adversely affected.

It should be noted that in this embodiment, the side wall 19B is provided on the cover 19 and the antenna element 34 of the antenna 17 is formed on the side wall 19B, but it is alternatively possible to provide the antenna element on a side wall of the mask 18 when such a side wall is formed. Further, in this embodiment, the antenna 17 is formed on the inner surface of the display cabinet 15, but it is alternatively possible to provide the antenna 17 on the inner surface of the main body cabinet 23.

According to this embodiment, the electronic device comprises a housing 20 including a bottom wall 19A and a side wall 19B rising from the circumference of the bottom wall 19A, an antenna 17 provided on the inner surface of the housing 20 and a part contained inside the housing 20 and having a radio wave absorption property, wherein the part having the radio wave absorption property is located at such a position that a predetermined gap D is maintained between the part and the side wall 19B of the housing 20, and at least a part of the antenna 17 is brought into tight contact with the inner surface of the side wall 19B of the housing 20.

With the above-described structure, a gap D of a predetermined distance is secured between a part of the antenna 17 and a part having a radio wave absorption property, and therefore it is possible to prevent the part having a radio wave absorption property from adversely affecting radio communications through the antenna 17. In this manner, even if the bottom wall 19A of the housing 20 is arranged to be close to the part having a radio wave absorption property, it is possible to prevent the communication performance in great deal from being adversely affected. This allows such an arrangement that the bottom wall 19A and the part are located close to each other, and thus the portable computer 11 can be reduced in size and thickness. Further, the antenna 17 is contained inside the housing 20, which makes the antenna 17 invisible from outside. Thus, in terms of design, it is possible to prevent the appearance of the electronic device from being degraded by the antenna 17 as it is visible from outside.

In this embodiment, the antenna 17 includes the antenna element 34 formed to be in tight contact with the inner surface of the side wall 19B and the antenna ground 35 formed to be in tight contact with the inner surface of the bottom wall 19A. With this arrangement, at least the antenna element 34, through which the transmission and reception of radio waves are carried out mainly, can be arranged to be a certain distance away from the part having a radio wave absorption property. In the meantime, as to the antenna ground 35, which requires a certain space for installation, it can be formed on the inner surface of the bottom wall 19A, and in the manner, the degree of freedom of the layout of each of the antennas 17 can be increased.

This embodiment comprises the wireless module 32 contained inside the housing 20 and the wiring portion 33 which connects the antenna 17 to the wireless module 32, and at least a part of the wiring portion 33 is formed to be in tight contact with the side wall 19B and the bottom wall 19A of the housing 20. With this structure, the part of the wiring portion 33 can be formed to be in tight contact with the side wall 19B and the bottom wall 19A of the housing 20 and therefore a space required for the installation of the wiring portion 33 can be reduced in size. It should be noted that in order to prevent the interference with the part having a radio wave absorption property, it is preferable that the wiring portion 33 should be located away from this part.

In this embodiment, the antenna 17 and at least a part of the wiring portion 33 are formed by printing carried out on the inner surface of the housing 20. In many cases, a coaxial cable or a lead wire is employed for electrically connecting the antenna 17 and the wireless module 32 to each other. With this arrangement, the antenna 17 and the wiring portion 33 can be formed of thin films having a very little thickness. In this manner, not further space is required for the installation of the antenna 17 and the wiring portion 33, and these members can be arranged in the vacant space. Thus, the size of the housing 20 can be reduced. In particular, the thickness of the antenna 17, which is formed by printing, is, for example, small as about 20 μm, and therefore the size of the housing can be significantly reduced as compared to such a case where a plurality of coaxial cables each having a diameter of 0.8 mm are arranged.

Further, according to the embodiment, both of the antenna 17 and the wiring portion 33 can be formed in one step, and therefore the step for installing these members can be omitted. In this manner, the antenna 17 and the wiring portion 33 can be simply formed. Further, fixing parts such as tapes, which are conventionally employed as a harness to fasten a plurality of coaxial cables together, fixation ribs formed in the display cabinet 15, and the like become unnecessary, and thus the number of parts can be decreased.

According to this embodiment, the housing 20 includes the main body cabinet 23 which houses the wireless module 32, and the display cabinet 15 having the bottom wall 19A and the side wall 19B rising from the circumference of the bottom wall 19A and configured to house the display. Here, the part having a radio wave absorption property is the display and the antenna 17 is formed on the inner surface of the display cabinet 15.

With the above-described structure, at least a part of the antenna 17 is formed to be in tight contact with the inner surface of the side wall 19B of the display cabinet 15. Therefore, the part of the antenna 17 can be located away from the display. With this arrangement, even if the bottom wall 19A of the display cabinet 15 is set close to the display, the radio communications are not substantially affected. In this manner, the display cabinet 15 can be reduced in size and thickness, and accordingly, the portable computer 11 as a whole can be reduced in size and thickness as well.

With the above-described structure, the display cabinet 15 includes the mask 18 arranged to correspond to the front surface of the display and the cover 19 which contains the bottom wall 19A and the side wall 19B and arranged to correspond to the rear surface of the display. With this structure, each of the antenna element 34 and the antenna ground 35 can be formed merely by performing printing on the cover 19 only, and thus the step for forming the antenna 17 can be simplified. Further, there is no need here to provide the opening 18A in the cover 19 so as to expose the display to the outside, such as the mask 18, and therefore a sufficient space can be secured for the installation of the antenna 17.

Next, an electronic device according to the second embodiment will now be described with reference to FIG. 4. A portable computer 41, which is an example of the electronic device according to the second embodiment, is similar in structure to that of the first embodiment except for a wiring portion 42. Here, the second embodiment will be described by focusing on the part which is different from that of the first embodiment. Thus, similar members and sections will be designated by the same reference numerals and the descriptions for these similar parts will not be repeated.

In the second embodiment, the wiring portion 42 is formed to be astride the main body unit 12 and the display unit 13. The wiring portion 42 comprises a coaxial cable 33B or a lead wire. The wiring portion 42 is connected by one end to the wireless module 32. The other end of the wiring portion 42 is connected to the antenna 17. The wiring portion 42 is connected to a conductor part 36 which connects an antenna element 34 and an antenna ground 35 to each other.

According to the second embodiment, with such a structure that the wiring portion 42 is formed of the coaxial cable 33B or the lead wire, it is possible to stabilize radio communications in the case where the signal transmission is electrically no stabilized due to wiring formed by printing.

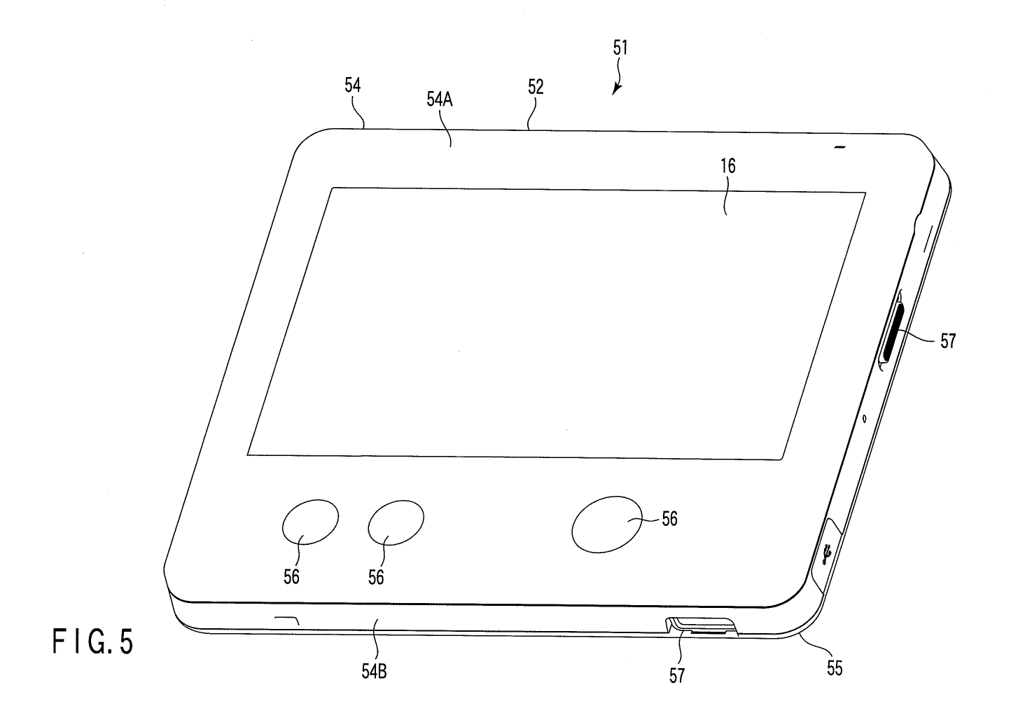

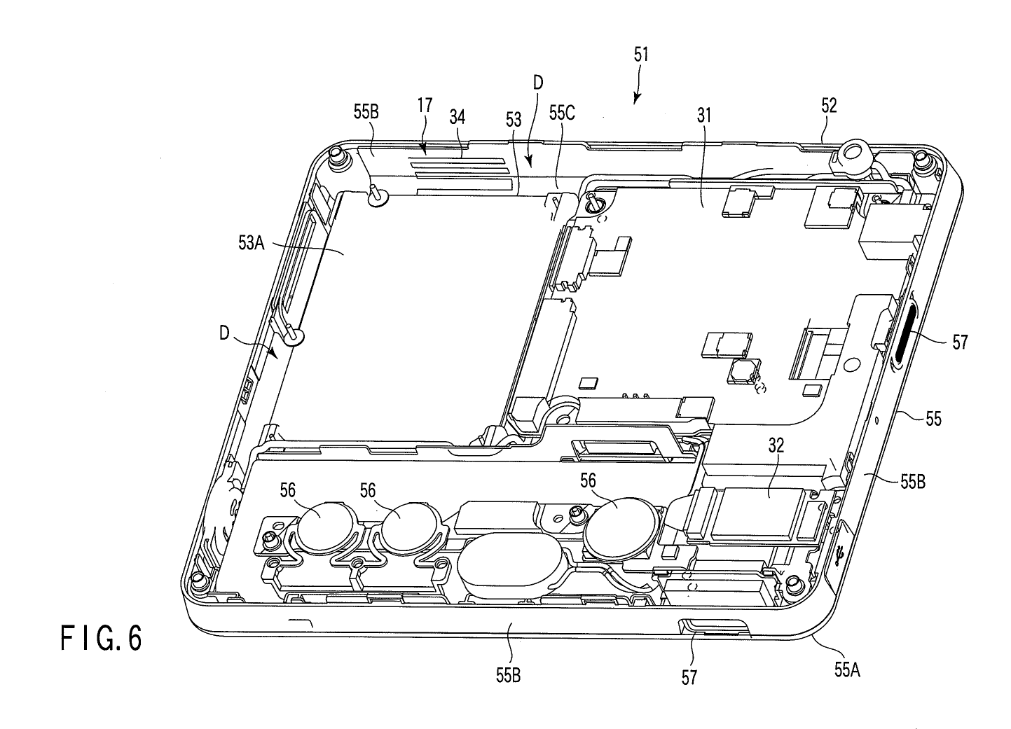

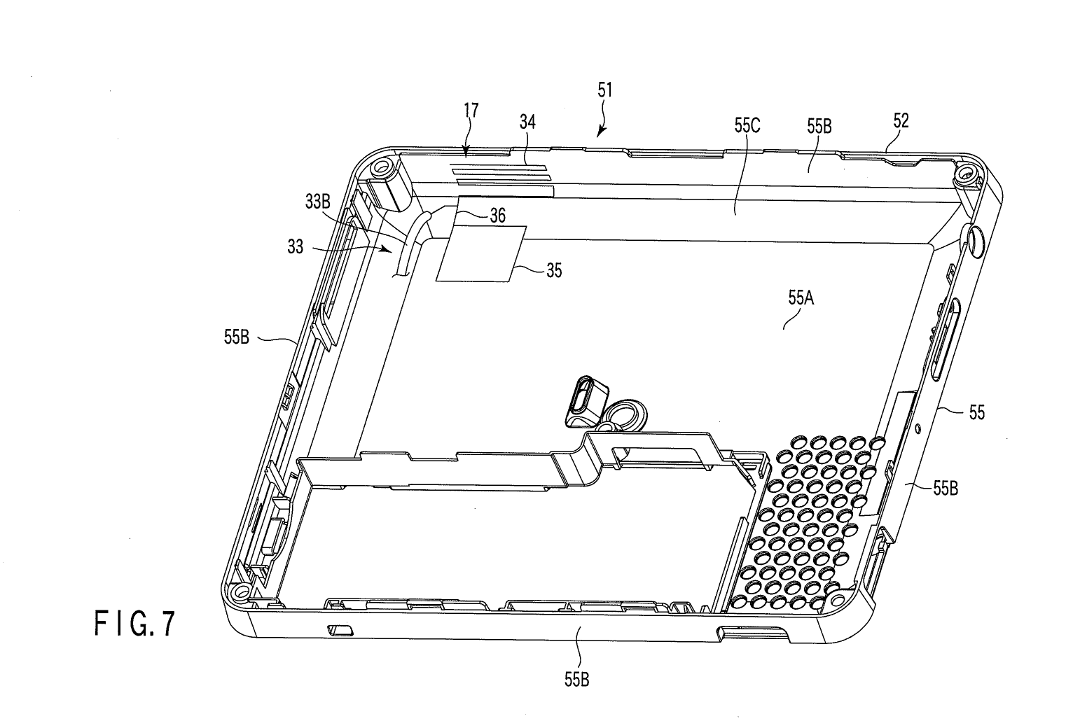

Subsequently, an electronic device according to the third embodiment will now be described with reference to FIGS. 5 to 7. A portable computer 51, which is an example of the electronic device according to the third embodiment, is substantially similar in structure to that of the first embodiment except that the computer comprises a main body unit without a keyboard or a display unit. Here, the third embodiment will be described by focusing on the parts which are different from that of the first embodiment. Thus, similar members and sections will be designated by the same reference numerals and the descriptions for these similar parts will not be repeated.

In the third embodiment, the portable computer 51 is a mobile information terminal of the so-called PDA (personal digital assistant) type. As can be seen in FIGS. 5 to 7, the portable computer 51 comprises only a main body unit, and includes a housing 52 which forms an enclosure. Further, the portable computer 51 contains, inside the housing 52, a liquid crystal display 16, which is an example of the display, a printed circuit board 31, a wireless module 32 mounted on the printed circuit board 31, a disk device 53, buttons 56 for entering data to the portable computer 51 and a connector to connect the computer to an external device. An antenna 17 is formed on an inner surface of the housing 52.

The housing 52 includes a top wall 54A formed into a frame shape, a bottom wall 55A opposing the top wall 54A and a side wall 55B formed to rise from an circumference of the bottom wall 55A. In the housing 52, a first portion 54 which includes the top wall 54A and a descending part 54B extending downwards from the top wall 54A can be detached from a second portion 55 which includes the bottom wall 55A and the side wall 55B. The housing 52 includes an inclined wall 55C formed to be inclined with respect to the bottom wall 55A, at a position between the side wall 55B and the bottom wall 55A. The housing 52 is formed of, for example, a synthetic resin.

The antenna 17 is formed as a metal coating film tightly attached to an inner surface of a cover 19. The antenna 17 includes an antenna element 34, with which transmission and reception of electromagnetic waves are mainly carried out, an antenna ground 35, which is provided mainly to broaden the band of the radio frequencies, and a conductive portion 36 which connects the antenna element 34 and the antenna ground 35 to each other. The antenna element 34, the antenna ground 35 and the conductive portion 36 are each formed of a material prepared by stacking thin films of, for example, copper, nickel and gold one on another by screen printing, and the thickness of the stacked multilayer is, for example, 20 μm. The antenna element 34 is formed on the inner surface of the side wall 55B. The antenna ground 35 is formed on the inner surface of the bottom wall 55A. The conductive portion 36 is formed on the inclined wall 55C. A wiring portion 33, which comprises a coaxial cable 33B having a diameter of, for example, 8 mm, is connected to the conductive portion 36. The wiring portion 33 is connected by one end to the conductive portion 36. The other end of the wiring portion 33 is connected to the wireless module 32.

A disk device 53 comprises, for example, a hard disk device which can read and write data with respect to a disk-like recording medium equipped therein. The disk device 53 includes a shielded case 53A made of, for example, metal. The shielded case 53A blocks radio waves from the outside as well as inhibits radio waves generating from the inside of the hard disk device from leaking to the outside. In this embodiment, the disk device 53 is an example of the part which has a radio wave absorption property. There is a gap D of a predetermined distance created between the disk device 53 and the side wall 55B of the housing 52. It should be noted that the disk device 53 is not limited to a hard disk device, but it may be a floppy (registered trademark) disk drive or an optical disk device which can record and reproduce data on and from a CD or DVD.

According to the third embodiment, the housing 52 houses the wireless module 32, the display and the part having a radio wave absorption property, altogether, and the part having a radio wave absorption property is the disk device 53, which can read and write data with respect to a disk-like recording medium. With this structure, an interval can be created between the antenna 17 formed on the side wall 55B of the casing 52 and the disk device 53. Therefore, it is possible to prevent the disk device 53 from adversely effecting radio communications through the antenna 17. Further, since the antenna 17 is formed thin by printing, it does not require a large space to install the antenna 17. Therefore, the size of the portable computer 51 can be reduced.

In this embodiment, the housing 52 includes a first portion 54 which includes the top wall 54A and a second portion 55 which includes a bottom wall 55A opposing the top wall 54A and the side wall 55B. With this structure, the antenna 17 can be formed in one step by carrying out printing on the second portion 55 of the housing 52. Thus, the step for forming the antenna 17 can be simplified.

Apart from the above, the electronic device of the present invention is not limited to those embodiments provided above. The electronic device of the present invention can be applied to mobile phones. Further, it is only natural that the electronic device of the present invention can be remodeled into various versions as long as the essence of the invention does not fall out of the scope thereof.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An electronic device comprising:
a housing comprising a bottom wall and a side wall rising from a circumference of the bottom wall;
an antenna provided on an inner surface of the housing; and
a component having a radio wave absorption property inside the housing,
wherein
the component is positioned a predetermined distance from the side wall of the housing; and
at least a part of the antenna is in substantially tight contact with an inner surface of the side wall of the housing.

2. The electronic device of claim 1, wherein the antenna further comprises:
an antenna element formed in substantially tight contact with the inner surface of the side wall; and
an antenna ground formed in substantially tight contact with an inner surface of the bottom wall.

3. The electronic device of claim 2, further comprising:
a wireless module inside the housing; and
a wiring portion configured to connect the antenna and the wireless module to each other;
wherein at least a part of the wiring portion is in substantially tight contact with the side wall and the bottom wall of the housing.

4. The electronic device of claim 3, wherein the antenna and at least a part of the wiring portion are formed by printing on the inner surface of the housing.

5. The electronic device of claim 4, wherein the housing further comprises:
a main body cabinet configured to hold the wireless module; and
a display cabinet comprising the bottom wall and the side wall rising from the circumference of the bottom wall and holding a display,
wherein
the component having a radio wave absorption property is the display; and
the antenna is formed on an inner surface of the display cabinet.

6. The electronic device of claim 5, wherein the display cabinet further comprises:
a mask facing a front surface of the display; and
a cover comprising the bottom wall and the side wall facing a rear surface of the display.

7. The electronic device of claim 4, wherein
the housing is configured to hold the wireless module, the display and the component having a radio wave absorption property, altogether; and
the component is a disk device configured to read and write data from a disk-like recording medium.

8. The electronic device of claim 7, wherein the housing comprises:
a first portion with a top wall; and
a second portion with a bottom wall opposing the top wall and the side wall.
